(19) United States
(12) Patent Application Publication
(10) Pub. No.: US 2024/0345515 A1
(43) Pub. Date: Oct. 17, 2024

(54) IMAGE FORMING APPARATUS AND FIXING DEVICE

(71) Applicant: CANON KABUSHIKI KAISHA, Tokyo (JP)

(72) Inventors: KOICHI KAKUBARI, Chiba (JP); AKIHIRO MAEDA, Tokyo (JP); HIROTO ITO, Chiba (JP); SHIGERU HIRANO, Tokyo (JP); IKUO NAKAMOTO, Chiba (JP); AKIKO TOKUUE, Ibaraki (JP)

(21) Appl. No.: 18/625,975

(22) Filed: Apr. 3, 2024

(30) Foreign Application Priority Data
Apr. 12, 2023 (JP) 2023-065266
Jul. 19, 2023 (JP) 2023-117863

(51) Int. Cl. G03G 15/20

(52) U.S. Cl. CPC G03G 15/2039; G03G 15/2064; G03G 2215/2035

(57) ABSTRACT

An image forming apparatus includes a fixing device to fix a toner image onto a recording material. The fixing device includes a heating unit, a pressure rotating member, a temperature detection unit, a storage unit, a reading unit, a sheet feeding unit, a conveyance unit, and a control unit. The pressure rotating member abuts the heating unit to form a nip portion. The storage unit stores information regarding a temperature rise rate of the fixing device. When the recording material is conveyed to the nip portion, the control unit controls the heating unit at a target temperature. Where a predetermined temperature lower than the target temperature is reached, the control unit controls the conveyance unit to start conveying the recording material from the sheet feeding unit to the nip portion. The control unit further determines the predetermined temperature based on the information read by the reading unit.

### BACKGROUND

### Field

The present disclosure relates to an image forming apparatus that forms an image on a recording material and a fixing device.

### Description of the Related Art

Recent image forming apparatuses using an electrophotographic method include fixing devices that fix a toner image onto a recording material. The fixing device performs the fixing by applying heat and pressure to the recording material. The fixing requires heat, and a fixing device that starts accumulating heat and performs fixing after a print start instruction is received has been put to actual use. The fixing device that starts accumulating heat after a print start instruction is received uses a fixing belt having a small heat capacity and accumulates heat in the fixing belt. Thus, the fixing device is able to discharge a recording material having been subjected to printing to a sheet discharge tray in a short time from a print start instruction. Japanese Patent Application Laid-Open No. 2020-013013 discusses an example of a fixing device using a fixing belt.

When a conventional fixing device is manufactured, the dimensions, the heat characteristics, and the temperature detection characteristics of parts included in the fixing device vary. For example, in the case of a fixing belt, the thicknesses of layers (a base layer, an elastic layer, and a surface layer) vary. In the case of a temperature detection thermistor, the resistance values and the shapes of elements vary.

As described above, various parts used in the conventional fixing device vary. Thus, even if the same target temperature is set, a temperature difference occurs between fixing devices.

In response to the above variations, an image forming apparatus having a memory regarding heat responsiveness is provided in the conventional fixing device, and an image forming apparatus main body reads the memory, thus dealing with variations that occur in each fixing device.

In an image forming apparatus that starts preheating the conventional fixing device after receiving a print start instruction, a target temperature of the fixing device and a conveyance permission temperature for permitting the conveyance of a recording material from a sheet feeding cassette are set. If the fixing device reaches the conveyance permission temperature, the image forming apparatus starts conveying the recording material. The fixing device reaches the target temperature by the time the recording material enters the fixing device.

The conveyance permission temperature is set with the temperature rise rate of the conventional fixing device reflected. However, as described above, variations due to an individual difference occur in the fixing device.

In typical techniques, the conveyance permission temperature is set in consideration of the above variations so that the temperature of the conventional fixing device does not fall below the target temperature when the recording material enters the fixing device. As a result, the conveyance permission temperature may be set to a high temperature, and the time taken from a print start instruction to the discharge of the first recording material in a job (so-called First Copy Output Time (FCOT)) may be delayed depending on the variations in the fixing device.

### SUMMARY

The present disclosure is directed to an image forming apparatus that prevents a delay in FCOT that occurs due to variations in a fixing device, thereby improving the FCOT.

According to an aspect of the present disclosure, an image forming apparatus includes a fixing device configured to fix a toner image onto a recording material, wherein the fixing device includes a heating unit configured to apply heat to the recording material, a pressure rotating member configured to abut the heating unit to form a nip portion, a temperature detection unit configured to detect a temperature of the heating unit, and a storage unit configured to store information regarding a temperature rise rate of the fixing device, a reading unit configured to read the information stored in the storage unit, a sheet feeding unit configured to feed the recording material, a conveyance unit configured to convey the recording material from the sheet feeding unit to the nip portion, and a control unit configured to control, when the recording material is conveyed to the nip portion, the heating unit at a target temperature, wherein, in a case where a predetermined temperature lower than the target temperature is reached, the control unit controls the conveyance unit to start conveying the recording material from the sheet feeding unit to the nip portion, and wherein, in determining the predetermined temperature, the control unit further determines the predetermined temperature based on the information read by the reading unit.

Further features of the present disclosure will become apparent from the following description of exemplary embodiments with reference to the attached drawings.

### BRIEF DESCRIPTION OF THE DRAWINGS

FIG. 1 is a diagram illustrating a sectional configuration of an image forming apparatus according to a first exemplary embodiment.

FIG. 2 is a control block diagram of the image forming apparatus according to the first exemplary embodiment.

FIG. 3 is a diagram illustrating a sectional configuration of a fixing device according to the first exemplary embodiment.

FIG. 4 is a schematic diagram illustrating a configuration of a fixing device heat characteristic measurement jig according to the first exemplary embodiment.

FIG. 5 is an example of temperature transition when a temperature rise characteristic of the fixing device is measured according to the first exemplary embodiment.

FIG. 6 is a flowchart illustrating an operation in a comparative example.

FIG. 7 illustrates start-up temperature transition in the comparative example.

FIG. 8 is a diagram illustrating a sectional configuration before and after the fixing device according to the present exemplary embodiment.

FIG. 9 is a flowchart illustrating an operation according to the first exemplary embodiment.

FIG. 10 illustrates start-up temperature transition according to the first exemplary embodiment.

FIG. 11 is examples of conveyance permission temperature correction coefficients according to the present exemplary embodiment.

FIG. 12 is a diagram illustrating a sectional configuration of a fixing device according to a second exemplary embodiment.

FIG. 13 is a control block diagram of an image forming apparatus according to the second exemplary embodiment.

FIG. 14 is a schematic diagram illustrating a configuration of a fixing device heat characteristic measurement jig according to the second exemplary embodiment.

FIG. 15 is an example of temperature transition when a temperature rise characteristic of the fixing device is measured according to the second exemplary embodiment.

FIG. 16 is a flowchart illustrating an operation in a comparative example.

FIG. 17 illustrates start-up temperature transition in the comparative example.

FIG. 18 is a flowchart illustrating an operation according to the second exemplary embodiment.

FIG. 19 illustrates start-up temperature transition according to the second exemplary embodiment.

FIG. 20 is a diagram illustrating a sectional configuration of a fixing device according to a third exemplary embodiment.

FIG. 21 is a control block diagram of an image forming apparatus according to the third exemplary embodiment.

FIG. 22 is a schematic diagram illustrating a configuration of a fixing device heat characteristic measurement jig according to the third exemplary embodiment.

FIG. 23 is an example of temperature transition when a temperature rise characteristic of the fixing device is measured according to the third exemplary embodiment.

FIG. 24 is a flowchart illustrating an operation in a comparative example.

FIG. 25 illustrates start-up temperature transition in the comparative example.

FIG. 26 is a flowchart illustrating an operation according to the third exemplary embodiment.

FIG. 27 illustrates start-up temperature transition according to the third exemplary embodiment.

### DESCRIPTION OF THE EMBODIMENTS

### <Image Forming Unit>

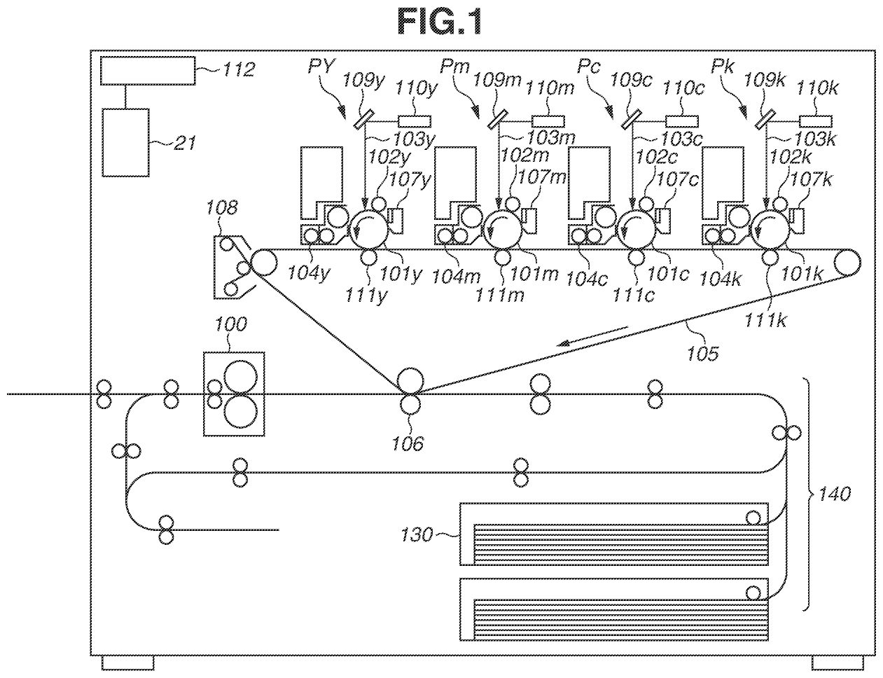

A first exemplary embodiment of the present disclosure will be described below. FIG. 1 is a diagram illustrating a sectional configuration of a color laser printer. In a first exemplary embodiment, a description is provided using as an example a color laser printer that is an image forming apparatus that forms an image using an electrophotographic process.

The image forming apparatus includes image forming units Py, Pm, Pc, and Pk. The image forming units Py, Pm, Pc, and Pk form yellow, magenta, cyan, and black toner images, respectively, on an intermediate transfer member 105. The following description is provided taking the yellow image forming unit Py as an example.

A photosensitive drum 101y as an image bearing member is rotationally driven at a predetermined process speed (peripheral speed) in the direction of an arrow. The photosensitive drum 101y is subjected to a charging process to a predetermined polarity by a charging device 102y, such as a charging roller, in the rotation process of the photosensitive drum 101y.

Next, an exposure process based on input image information is performed using laser light 103y output from a laser optical system 110y to a charging process surface of the photosensitive drum 101y. The laser optical system 110y outputs the laser light 103y modulated (turned on or off) in accordance with a time series electric digital pixel signal of target image information from an image signal generation apparatus, such as an image reading apparatus (not illustrated), thus performing scanning exposure on the surface of the photosensitive drum 101y. As a result, the scanning exposure forms an electrostatic latent image corresponding to the image information on the surface of the photosensitive drum 101y. A mirror 109y deflects the laser light 103y output from the laser optical system 110y onto the exposure position on the photosensitive drum 101y.

The electrostatic latent image formed on the photosensitive drum 101y is visualized using yellow toner by a development device 104y. This yellow toner image is transferred to the surface of the intermediate transfer member 105 in a primary transfer unit 111y that is the contact portion of the photosensitive drum 101y and the intermediate transfer member 105. Toner remaining on the surface of the photosensitive drum 101y is cleaned by a cleaner 107y.

The above cycle of charging, exposure, development, primary transfer, and drum cleaning is also performed by the image forming units Pm, Pc, and Pk. As a result, a magenta toner image, a cyan toner image, and a black toner image are formed on the intermediate transfer member 105. The multicolor toner images formed by sequentially superimposing the toner images on the intermediate transfer member 105 are collectively secondarily transferred onto a recording material in a secondary transfer unit 106.

Toner remaining on the intermediate transfer member 105 is cleaned by a cleaner 108.

If a print instruction is received, a recording material stored in a sheet feeding cassette 130 is conveyed to a position immediately before the secondary transfer unit 106 and kept waiting by a conveyance unit 140. Then, in synchronization with toner images formed on the intermediate transfer member 105, a toner image is formed on the recording material.

The recording material having passed through the secondary transfer unit 106 is introduced into a fixing device 100 serving as an image heating device and subjected to a fixing process (an image heating process) for the unfixed toner image borne on the recording material. The recording material having been subjected to the fixing process is discharged to a sheet discharge tray, and the series of processes of the image forming operation ends.

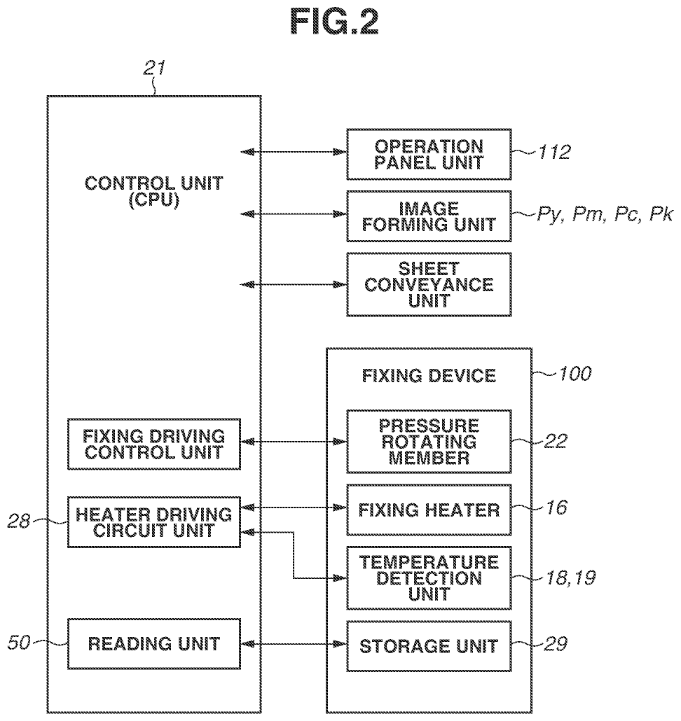

In the image forming apparatus, as illustrated in FIG. 2, a control unit 21 typified by a central processing unit (CPU) and an operation panel unit 112 serving as an interface for communicating with a user or an external device and accessing the apparatus are provided. The control unit 21 coordinates the operation of the entirety of the image forming apparatus by controlling the chain of command between devices while monitoring and controlling the states of components in the apparatus, such as the image forming units Py, Pm, Pc, and Pk, the recording material conveyance unit 140, and the fixing device 100.

### <Fixing Device>

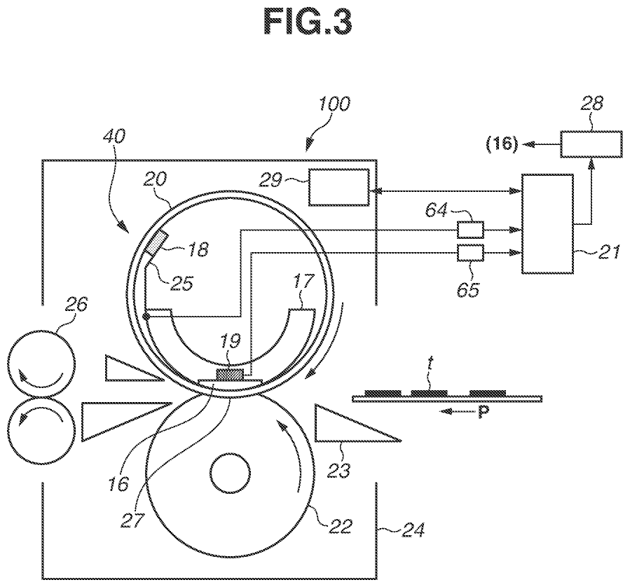

FIG. 3 is a diagram illustrating a sectional configuration of the fixing device 100.

A fixing belt 20 is an endless belt that is endless and cylindrical and includes an elastic layer. A pressure rotating member 22 abuts the fixing belt 20 to form a nip portion. A heater 16 (also referred to as fixing heater) which is a heating member heats the fixing belt 20. A heater holder 17 has heat resistance with an approximately U-shaped sectional shape and holds the heater 16. The heater 16 is bonded and fixed to a lower surface of the heater holder 17 along the longitudinal direction of the heater holder 17 and configured to be slidable in contact with the fixing belt 20. The fixing belt 20 is externally fitted to the periphery of the heater holder 17.

In the fixing belt 20, a silicone rubber layer (an elastic layer) having a thickness of about 300 μm is formed on a cylindrical base material formed of cylindrical stainless steel having a thickness of about 30 μm. The outer surface of the elastic layer is coated with a perfluoroalkoxy alkane (PFA) resin tube. The PAF resin tube is a surface layer of the fixing belt 20 and has a thickness of about 30 μm.

The pressure rotating member 22 (a pressure roller) has a structure where a silicone rubber layer having a thickness of about 2.5 mm, and further, a PFA resin tube having a thickness of about 50 μm are laminated on the surface of an iron (Fe) metal core. Both end portions of the metal core of the pressure rotating member 22 are rotatably held between both side plates of the fixing device 100. The pressure rotating member 22 is connected to a motor and rotationally driven. The pressure rotating member 22 abuts the fixing belt 20 to form a nip portion. Further, the pressure rotating member 22 is rotationally driven, so that the fixing belt 20 is driven to rotate.

In the fixing device 100, a heating unit 40 including the heater 16, the heater holder 17, and the fixing belt 20 is installed. The fixing belt 20 included in the heating unit 40 is placed parallel to the pressure rotating member 22. The heating unit 40 is configured to apply heat necessary for fixing to a recording material.

The heater holder 17 is formed of liquid-crystal polymer resin having high heat resistance and configured to hold the heater 16 and also guide the circling trajectory of the fixing belt 20. Both end portions of the heater holder 17 are biased in the rotational axis direction of the pressure rotating member 22 with a pressure of 157 N on each side, or a total pressure of 314 N, by a pressurization mechanism (not illustrated). As a result, a surface of the heater 16 is caused to abut the elastic layer of the pressure rotating member 22 with the fixing belt 20 therebetween with a predetermined pressing force against the elastic layer, thus forming a nip portion 27 having a predetermined width required for fixing.

The heater 16 includes a resistance heating element B obtained by applying a conductive paste including a silver-palladium alloy onto a ceramic substrate made of alumina or aluminum nitride in a uniform film having a thickness of about 10 μm by a screen printing method. Glass coating is applied onto the heating element B to ensure pressure resistance.

The fixing device 100 includes temperature detection units. In the width direction of the recording material orthogonal to the conveyance direction of the recording material, the temperature detection units detect the temperatures of a sheet passage area through which the recording material passes. Temperature detection units 18 and 19 detect the temperatures of the heating unit 40. The detection temperatures detected by the temperature detection units 18 and 19 are used to control the fixing belt 20 at a target temperature. If the temperature detection unit 18 or 19 detects an excessive temperature rise, the temperature detection unit 18 or 19 determines that an error occurs. Then, control is performed to suspend a print job. The temperature detection units 18 and 19 according to the present exemplary embodiment are thermistors. More specifically, the temperature detection unit 18 is a thermistor (a belt back thermistor) that detects the temperature of the inner peripheral surface of the fixing belt 20. The temperature detection unit 19 is a thermistor (a heater back thermistor) that detects the temperature of the back surface of the heater 16 (a surface opposite to the surface that slides in contact with the fixing belt 20). The belt back thermistor 18 is installed in elastic contact with the inner peripheral surface of the fixing belt 20 and is configured to detect the temperature of the inner surface of the fixing belt 20. Specifically, the belt back thermistor 18 is attached to the end of an arm 25 made of stainless steel that is fixedly supported by the heater holder 17. The arm 25 elastically swings to maintain the state where the belt back thermistor 18 is always in contact with the inner surface of the fixing belt 20. The belt back thermistor 18 and the heater back thermistor 19 are connected to the control unit (CPU) 21 serving as a control unit via analog-to-digital (A/D) converters 64 and 65, respectively. The control unit 21 samples the output from each thermistor in a predetermined period and is configured to reflect the thus obtained temperature information on temperature control. That is, based on the outputs of the belt back thermistor 18 and the heater back thermistor 19, the control unit 21 determines details of temperature adjustment control of the heater 16 and controls the application of a current to the heater 16 using a heater driving control unit 28 that is a power supply unit. The temperature adjustment control method of the fixing device 100 determines the value of power to be supplied to the heater 16 mainly so that the detection temperature value of the belt back thermistor 18 is stably maintained at a desired temperature. More specifically, the value of power to be supplied to the heater 16 is calculated based on the target temperature, the detection temperature, the temperature change amount per unit time, the heater input power value, and a proportional-integral (PI) control parameter of the belt back thermistor 18. In this way, the fixing belt 20 can reach the target temperature early and be stably maintained at the target temperature. At this time, since a direct heating source is the heater 16, the detection temperature and the temperature change amount of the heater back thermistor 19 are also supplementarily subjected to PI control so that the temperature of the fixing belt 20 does not suddenly excessively change. Consequently, the temperature of the inner surface of the fixing belt 20 stabilizes earlier.

A storage unit 29 stores individual information regarding heat responsiveness that is provided in the fixing device 100. This apparatus employs a non-volatile memory such as a non-volatile random-access memory (NVRAM), but may employ the format of an integrated circuit (IC) tag such as radio-frequency identification (RFID) or a Quick Response (QR) code (registered trademark). When the fixing device 100 is attached to the image forming apparatus, the storage unit 29 in this example reads the stored information using a reading unit 50 in the image forming apparatus. The information read by the reading unit 50 is sent to the control unit 21 and utilized to determine the adjusted temperature of the fixing belt 20 by the storage unit 29 and the control unit (CPU) 21 of the image forming apparatus communicating with each other.

As another application, the storage unit 29 is also configured to appropriately store operation history information (counter information, print information, and occurrence history information regarding an error or a jam) of a specific fixing device 100 so that when an abnormality occurs in the fixing device 100, it is easy to investigate the cause of the abnormality. The image forming apparatus in this example assumes the replacement of the fixing device 100 when the fixing device 100 excesses its lifetime or a failure occurs in the fixing device 100, and therefore, a part of the fixing device 100 includes the storage unit 29. However, in a case where the unit of replacement is not the fixing device 100 but the heating unit 40, it is desirable that the heating unit 40 should include the storage unit 29. For an image forming apparatus that does not assume the replacement of the fixing device 100 or the replacement of the heating unit 40, a part of the image forming apparatus may include the storage unit 29. The information stored in the storage unit 29 will be described below.

In the present exemplary embodiment, the storage unit 29 is placed on the inner peripheral surface of a cover 24 included in the fixing device 100. A predetermined space is to be provided to place the storage unit 29, and the cover 24 is the placement location of the storage unit 29 in the present exemplary embodiment. Further, the storage unit 29 is placed on the inner peripheral surface of the cover 24, which reduces opportunities for the user to touch the storage unit 29 and decreases the risk of a failure of the storage unit 29 due to the user's touch of the storage unit 29.

If an image forming operation is started, the pressure rotating member 22 is rotationally driven at a predetermined peripheral speed in the direction of an arrow in FIG. 3. In a relationship where the fixing belt 20 abuts the pressure rotating member 22, the fixing belt 20 is driven by the pressure rotating member 22 and rotates at a predetermined speed. At this time, the inner peripheral surface of the fixing belt 20 enters the state where the fixing belt 20 is driven to rotate in the direction of an arrow around the outer periphery of the heater holder 17 while sliding in close contact with a sliding contact surface of the heater 16. Heat-resistant grease is applied to the inner surface of the fixing belt 20 and ensures the sliding contact performance between the heater holder 17 and the inner surface of the fixing belt 20.

If the pressure rotating member 22 is rotationally driven and the cylindrical fixing belt 20 accordingly enters the state where the fixing belt 20 is driven to rotate, a current is applied to the heater 16. When the fixing belt 20 reaches the target temperature, the recording material bearing an unfixed toner image T is guided along an entrance guide 23 and introduced into the nip portion 27.

In the nip portion 27, the toner image bearing surface side of the recording material is in close contact with the outer peripheral surface of the fixing belt 20, and the recording material moves together with the fixing belt 20. When the recording material is subjected to a nip/conveyance process in the nip portion 27, the heat of the fixing belt 20 is applied to the recording material, and the unfixed toner image T is fused and fixed onto the recording material. The recording material having passed through the nip portion 27 is curvature-separated from the fixing belt 20 and discharged by fixing sheet discharge rollers 26.

### <Storage of Information in Memory>

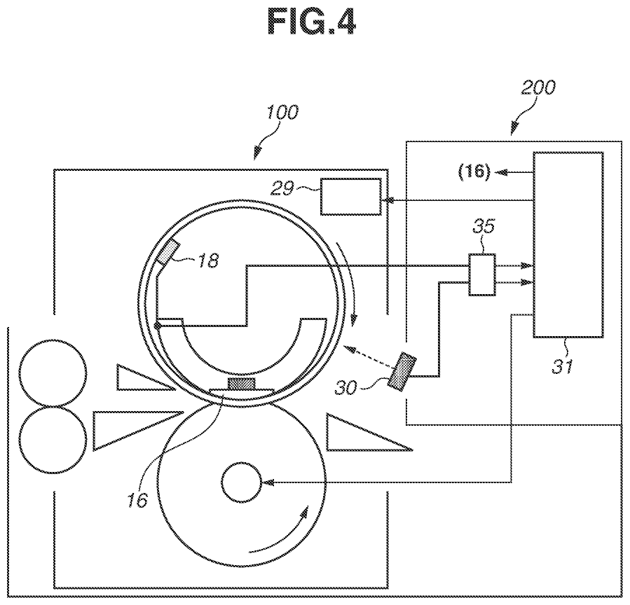

FIG. 4 is a diagram illustrating the configuration of a fixing device heat characteristic measurement jig 200 installed in the final process after the completion of the fixing device 100 in the process of manufacturing the fixing device 100. The measurement jig 200 measures temperature rise characteristic information regarding the heater 16 or the fixing belt 20 as the heat response characteristic of the fixing device 100 and stores the temperature rise characteristic information as information in the storage unit 29 of the fixing device 100.

The measurement jig 200 can perform drive and belt inner surface temperature adjustment control in the state where the fixing device 100 is alone. The measurement jig 200 can output the detection value of the belt back thermistor 18 via an A/D converter 35 within the jig 200, and at the same time, synchronously measure the temperature of the surface of the fixing belt 20 using a non-contact temperature detection unit 30 installed in the jig 200.

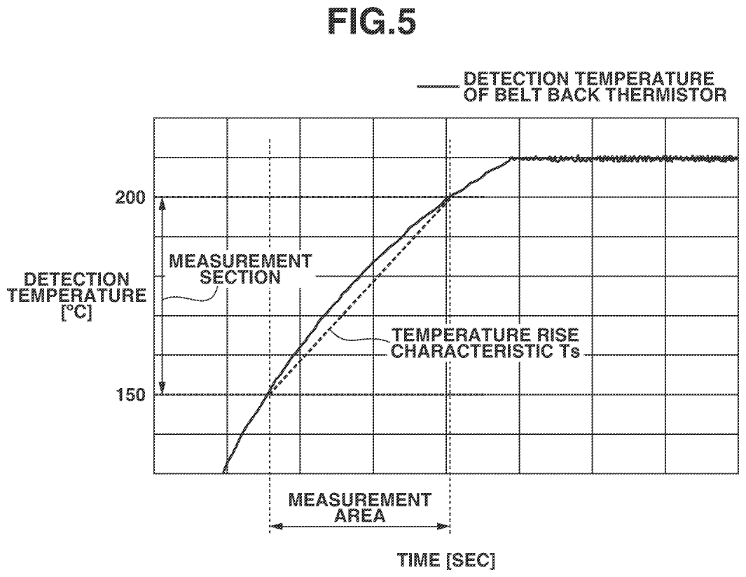

FIG. 5 illustrates start-up temperature transition acquired by the measurement jig 200 measuring a certain specific fixing device 100. Measurement conditions in this example were as follows.

After the completion of the fixing device 100, the measurement was started from a normal temperature stable state (25±4° C.). The start-up power of the heater 16 was 500 W±3%. The adjusted temperature of the belt back thermistor 18 was 210° C. The driving time was 60 seconds from when the fixing belt 20 reached the adjusted temperature. Regarding temperature rise characteristics information Ts to be written to the storage unit 29 in the present exemplary embodiment, the rising temperature per unit time of the fixing device 100 measured under the above measurement conditions during start-up temperature transition from 150° C. to 200° C. is the temperature rise characteristic.

The above measurement conditions are conditions for detecting the difference between each individual with high accuracy, and are not limited to the above values.

A calculation processing unit 31 within the measurement jig 200 stores either one or both of the detection temperature of the belt back thermistor 18 and the detection temperature of the non-contact temperature detection unit 30 during the above start-up period in a sampling period of 100 milliseconds (ms). After the completion of the measurement, the calculation processing unit 31 calculates the temperature rise characteristic information Ts and executes an operation of writing the temperature rise characteristic information Ts to the storage unit 29 in the fixing device 100.

It is known that the temperature rise characteristic information Ts regarding the fixing belt 20 under predetermined conditions varies mainly due to the following factors. The factors include the thickness of the elastic layer and the thickness of the surface layer of the fixing belt 20, the detection sensitivity of the belt back thermistor 18, the shape and the contact pressure of the arm (the backup member) 25, and the uniformity of the heat-resistant grease initially applied to the inner peripheral surface of the fixing belt 20. The variations due to the factors related to these members can also be reduced by increasing the accuracy of the dimensions of components. However, the method for increasing the accuracy of the dimensions of components increases cost and therefore is difficult to employ. The present disclosure is directed to, based on the difference in temperature rise characteristic between each individual fixing device 100 due to the variations in these members, measuring the temperature rise characteristic and controlling and utilizing the resulting temperature rise characteristic, thus shortening the time until a recording material is output.

In the measurement jig 200 for the fixing device 100 described here, the surface temperature measurement point of the fixing belt 20 is an area immediately before the nip in the rotational direction in this example, but may be any peripheral position. Alternatively, the temperature of the surface of the fixing belt 20 may be measured at a plurality of points or by performing continuous scanning in the longitudinal direction of the fixing device 100.

The specific temperature rise characteristic information Ts stored in the storage unit 29 is utilized to correct a permission temperature when the fixing device 100 is attached to the image forming apparatus and caused to operate. The method will be described in detail in the following paragraphs.

### <Image Forming Processing 1>

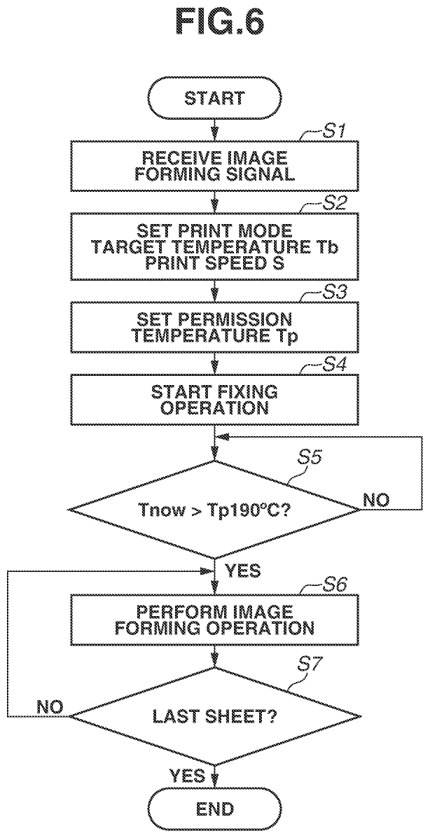

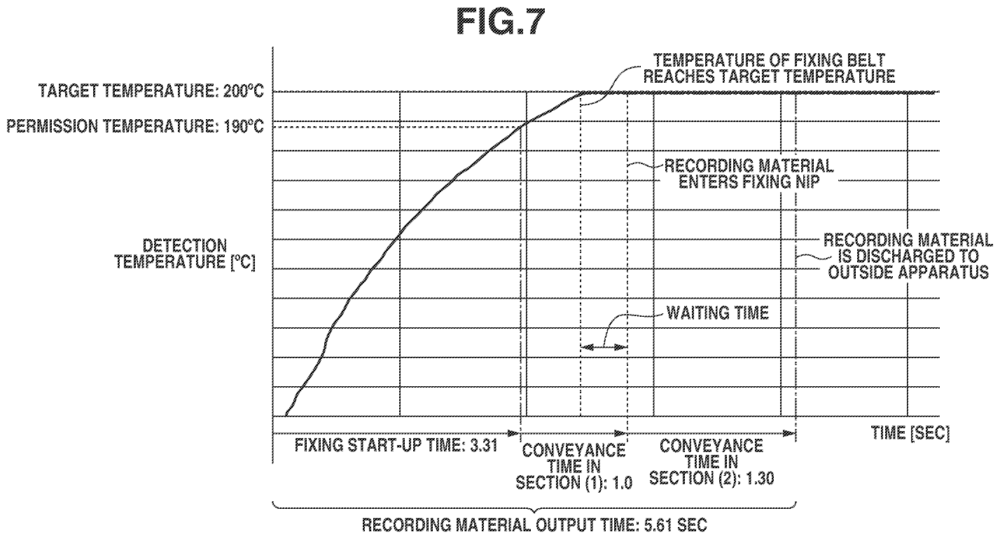

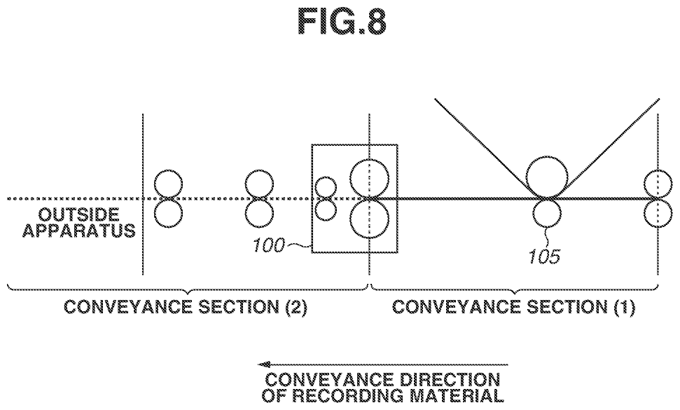

Initially, with reference to a flowchart in FIG. 6, a diagram illustrating temperature transition in FIG. 7, and a diagram illustrating the conveyance path of a recording material before and after the fixing device in FIG. 8, an image forming process in a comparative example is described.

In step S1, if the control unit 21 receives an image forming signal, then in step S2, the control unit 21 sets a print mode.

At this time, the control unit 21 performs temperature adjustment control of the fixing belt 20 based on the detection temperature of the belt back thermistor 18. In the temperature adjustment control, recording material information (the type, the grammage, and the size) regarding a recording material to be used in the image formation, image information (a monochrome mode or a color mode), and outside air temperature information are used. In the present exemplary embodiment, the control unit 21 determines a target temperature Tb and a print speed S based on an internal table. For example, the control unit 21 sets plain paper of 64 gram per square meter (gsm) (the recording material information), the color mode (the image information), and Tb=200° C. and S=100% in a 25° C. environment (the outside air temperature information).

Next, in step S3, the control unit 21 sets a permission temperature Tp that is a predetermined temperature for permitting the conveyance of the recording material.

The permission temperature Tp is determined based on the conveyance path length (a conveyance section (1) illustrated in FIG. 8) of the image forming apparatus. When the heater 16 is started up with the maximum setting power, the control unit 21 starts an image forming operation on the photosensitive drums 101 at a timing when the detection temperature is lower by ΔT° C. than when the fixing belt 20 reaches a print adjusted temperature Tb (also referred to as target temperature Tb). As a result, the recording material bearing a toner image is conveyed to the nip portion 27 just at the timing when the fixing belt 20 reaches the temperature Tb.

After a print instruction is received, the fixing device 100 according to the present exemplary embodiment starts heating the fixing belt 20 so that the fixing belt 20 reaches the target temperature Tb. At this time, if the conveyance unit 140 starts feeding the sheet from the sheet feeding cassette 130 after the fixing belt 20 reaches the target temperature Tb, First Copy Output Time (FCOT) becomes late. Accordingly, the FCOT is hastened by setting the permission temperature Tp to a temperature lower than the target temperature Tb.

In the comparative example, using a fixing device 100 that has the lowest temperature rise characteristic information Ts among variations in fixing devices as a reference, the permission temperature Tp=190° C. is set to a reference.

The individual fixing device 100 having the lowest temperature rise characteristic is used as a reference, so that it is possible to avoid the occurrence of defective fixing caused by the fixing belt 20 failing to reach the print adjusted temperature Tb at the time when the recording material reaches the nip portion 27.

In step S4, the control unit 21 starts driving the pressure rotating member 22 and also starts applying a current to the heater 16 via the heater driving control unit 28.

In step S5, if a detection temperature Tnow of the belt back thermistor 18 satisfies a conditional expression (Tnow>190° C.) (YES in step S5), then in step S6, the control unit 21 permits the feeding of the recording material and transmits a command to form images on the photosensitive drums 101.

In this manner, in step S6, the control unit 21 repeats an image forming operation while controlling the temperature of the fixing belt 20. In step S7, if the control unit 21 detects the last sheet (YES in step S7), an image forming operation end process (the stop of the temperature adjustment, the turning off of high-voltage components, and the stop of the driving mechanism) is completed, and the series of processes of the flowchart is ended.

FIG. 7 illustrates the transition of the output of the belt back thermistor 18 when a fixing device 100 having a high temperature rise characteristic prints plain paper in the comparative example.

In FIG. 7, the time until the recording material is output is 5.61 seconds. A breakdown of the time is as follows. It takes 3.31 seconds from when the application of a current to the heater 16 is started to when the detection temperature reaches a conveyance permission temperature Tp of 190° C. It takes 1.0 second for the recording material to be conveyed through the section (1) after that. It takes 1.3 seconds for the recording material to pass through the nip portion 27 and the rear end of the recording material to be discharged to outside the apparatus in the section (2). As described above, the conveyance times in the sections (1) and (2) are determined based on the conveyance path length and the conveyance speed and therefore are constant regardless of the individuality of the fixing device 100.

However, during the conveyance time in the section (1) from when the detection temperature reaches the conveyance permission temperature Tp to when the recording material enters the nip portion 27, the temperature of the fixing belt 20 quickly reaches the print adjusted temperature Tb, and the fixing device 100 is in the state where the fixing device 100 waits for the recording material to enter the nip portion 27. This is because, as described above, the permission temperature Tp is set using the individual fixing device 100 having the lowest temperature rise characteristic as a reference, and therefore does not match the temperature rise speed of the fixing device 100 having a high temperature rise characteristic.

### <Image Forming Flow 2>

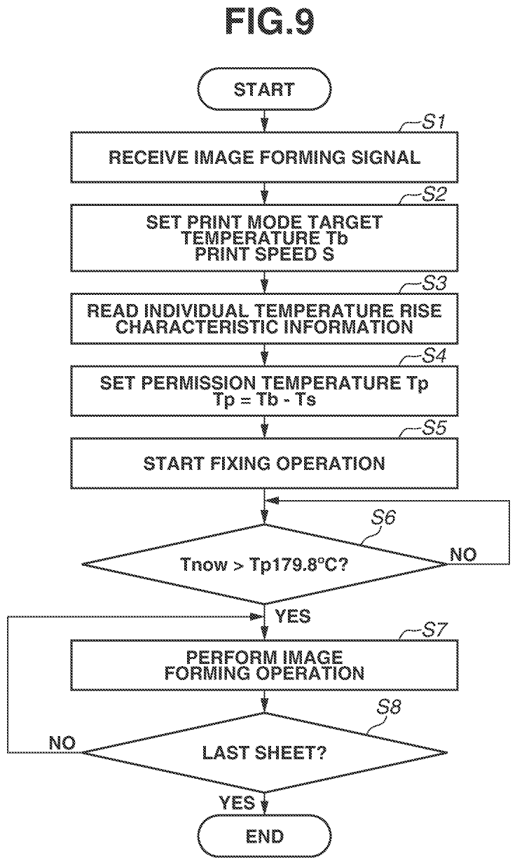

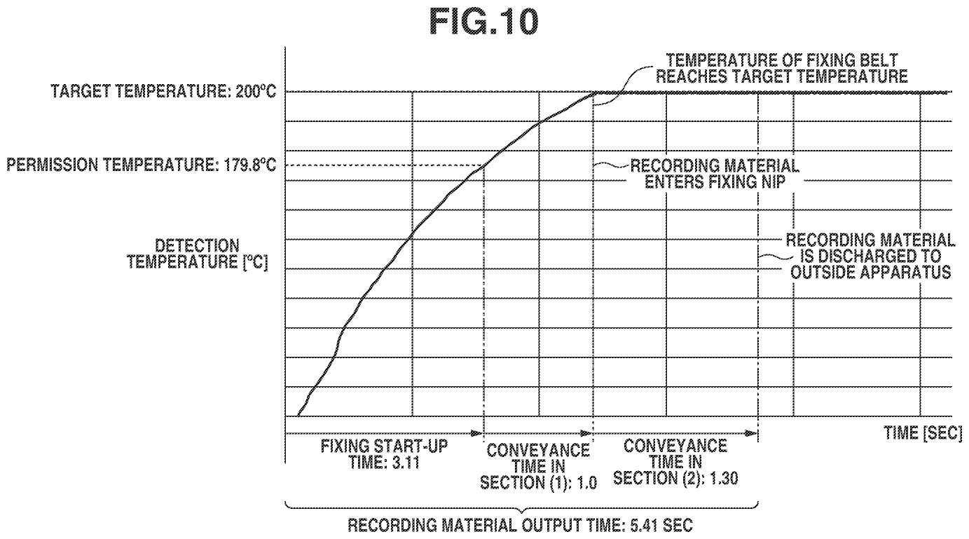

Next, with reference to a flowchart in FIG. 9 and a diagram illustrating temperature transition in FIG. 10, an image forming process according to the present exemplary embodiment is described.

The operations in steps S1 and S2 are similar to those in the comparative example, and therefore are not described. In step S3, the control unit 21 calculates a permission temperature Tp based on the information Ts regarding the temperature rise characteristic in the storage unit 29 of the fixing device 100 read by the reading unit 50. The information regarding the temperature rise characteristic described here is the rising temperature per unit time measured in the above assembling process.

Next, in step S4, the control unit 21 determines the permission temperature Tp according to the following formula using the temperature rise characteristic information Ts=10.2 (° C./sec) and the print adjusted temperature Tb.

Tp=Tb−{Ts×the time required to pass through the conveyance section (1)} Since the time required to pass through the conveyance section (1) is 1 second, Tp=190−10.2×1=179.8° C.

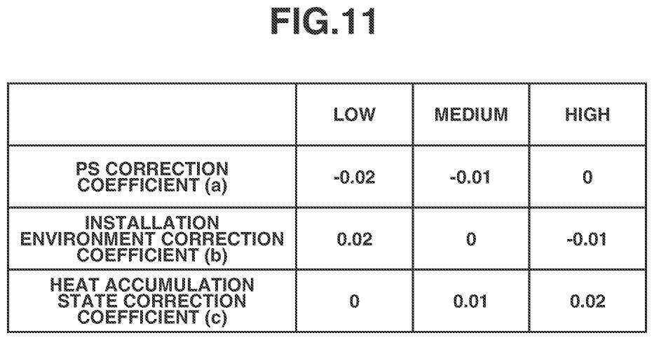

In this example, the sheet is passed in the plain paper mode from the state where the fixing device 100 is cold in a normal environment. Alternatively, as in an ambient temperature, a print speed, and a heat accumulation state as illustrated in FIG. 11, an optimal temperature correction value Tp′ may be calculated by applying correction coefficients for the respective items based on information regarding a high-temperature environment, low-speed sheet passage, and the elapsed time from a previous job as in the following equation.

$${Tp}^{′} = Tp ( 1 + ( a + b + c ) )$$

The correction coefficient table in FIG. 11 is illustrated at three levels, but may be set with respect to each representative actual temperature or speed of each item, and a value between representative values may be obtained by linearly complementing the representative values.

To prevent the recording material from entering the nip portion 27 at a temperature at which defective fixing occurs even if a reading error occurs in the storage unit 29, upper and lower limits may be set in advance on the temperature correction value Tp′.

In step S5, the control unit 21 starts driving the pressure rotating member 22 and also starts applying a current to the heater 16 via the heater driving control unit 28.

If a detection temperature Tnow of the belt back thermistor 18 satisfies a conditional expression (Tnow>179.8° C.) (YES in step S6), then in step S7, the control unit 21 permits the feeding of the recording material. The conveyance unit 140 conveys the recording material from the sheet feeding cassette 130. Further, the control unit 21 transmits a command to form images on the photosensitive drums 101.

In this manner, in step S7, the control unit 21 repeats an image forming operation while controlling the temperature of the fixing belt 20. In step S8, if the control unit 21 detects the last sheet (YES in step S8), an image forming operation end process (the stop of the temperature adjustment, the turning off of high-voltage components, and the stop of the driving mechanism) is completed, and the series of processes of the flowchart is ended.

The control unit 21 also gives an instruction to convey a recording material from a component other than the sheet feeding cassette 130. For example, the component may be a manual-bypass cassette. The control unit 21 provides a conveyance instruction with a location where the conveyance of a recording material to a fixing nip is started set to a sheet feeding unit.

FIG. 10 illustrates the transition of the output of the belt back thermistor 18 when a fixing device 100 having a high temperature rise characteristic prints plain paper using the control in this example.

In FIG. 10, the time until the recording material is output is 5.41 seconds, which is 0.2 seconds faster than in the comparative example.

A breakdown of the time is as follows. It takes 3.11 seconds from when the application of a current to the heater 16 is started to when the detection temperature reaches a conveyance permission temperature Tp of 179.8° C. It takes 1.0 second for the recording material to be conveyed through the section (1) after that. It takes 1.3 seconds for the recording material to pass through the nip portion 27 and the rear end of the recording material to be discharged to outside the apparatus in the section (2).

In this example, the conveyance permission temperature Tp is corrected using the temperature rise characteristic of each individual fixing device 100, so that the fixing belt 20 reaches the print adjusted temperature Tb at the timing when the recording material is conveyed and enters the nip portion 27. Thus, a waiting time does not occur.

As described above, as a result of actually evaluating sheet passage in the fixing device 100 for which the print adjusted temperature Tb of the inner surface of the belt 20 is determined to be 200° C. according to the image forming processing in FIG. 9, it has been demonstrated that as illustrated in FIG. 10, the time from when the application of a current to the heater 16 is started to when the first recording material is output can be shortened as follows: 5.41 seconds in the control according to the present disclosure, whereas 5.61 seconds in the comparative control.

In the present exemplary embodiment, the temperature rise per unit time of the fixing belt 20 measured in the assembling process is stored as the temperature rise characteristic in a memory and used as a conveyance permission temperature correction value in a printing operation. Similarly, the time required to rise to a predetermined temperature when certain power is input to a heat source may be stored as the temperature rise characteristic in a memory and used as a conveyance permission temperature correction value in a printing operation.

A second exemplary embodiment of the present disclosure will be described below. In the first exemplary embodiment, the conveyance permission temperature is controlled based on the temperature of the belt back thermistor 18. In the second exemplary embodiment, the conveyance permission temperature is controlled based on the temperature of a heater back thermistor 19. Portions similar to those of the first exemplary embodiment are not described below, and only different portions are described below.

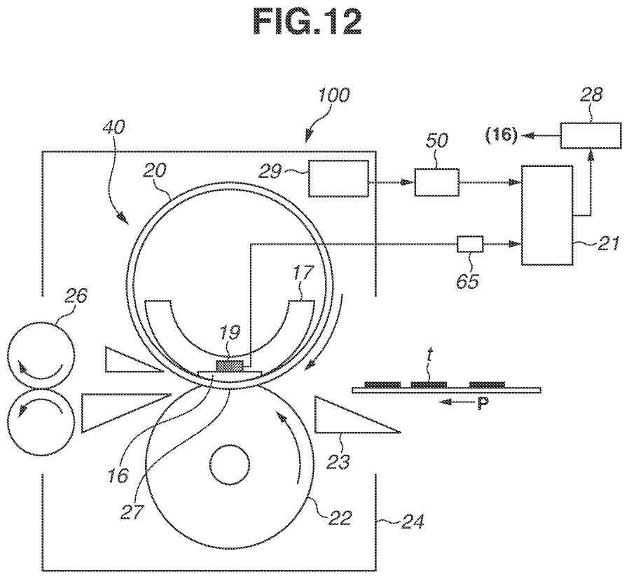

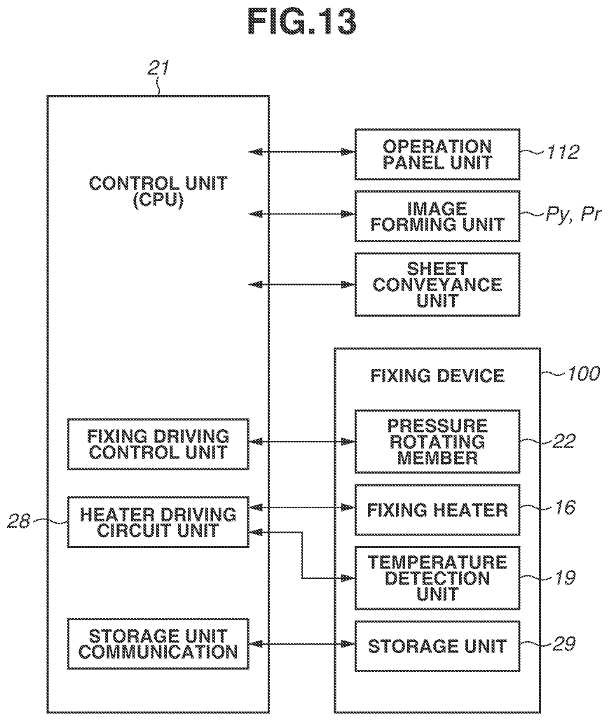

FIG. 12 is a diagram illustrating a sectional configuration of the fixing device 100 according to the present exemplary embodiment. The present exemplary embodiment is different from the first exemplary embodiment in that the fixing device 100 does not have a belt back thermistor. FIG. 13 is a control block diagram according to the present exemplary embodiment.

### <Fixing Device>

The fixing device 100 includes a temperature detection unit. In the width direction of the recording material orthogonal to the conveyance direction of the recording material, the temperature detection unit detects the temperature of a sheet passage area through which the recording material passes. A temperature detection unit 19 detects the temperature of the heating unit 40. The detection temperature detected by the temperature detection unit 19 is used to control the fixing belt 20 to be at a target temperature. If the temperature detection unit 19 detects an excessive temperature rise, the temperature detection unit 19 determines that an error occurs. Then, a control to suspend a print job is performed. The temperature detection unit 19 according to the present exemplary embodiment is a thermistor. More specifically, the temperature detection unit 19 is a thermistor (a heater back thermistor) that detects the temperature of the back surface of the heater 16 (a surface opposite to the surface that slides in contact with the fixing belt 20). The heater back thermistor 19 is connected to the control unit (CPU) 21 serving as a control unit via an A/D converter 65. The control unit 21 samples the output from the heater back thermistor 19 in a predetermined period and is configured to reflect the thus obtained temperature information on temperature control. That is, based on the output of the heater back thermistor 19, the control unit 21 determines the details of temperature adjustment control of the heater 16 and controls the application of a current to the heater 16 using a heater driving control unit 28 that is a power supply unit. The temperature adjustment control method of the fixing device 100 determines the value of power supplied to the heater 16 mainly so that the detection temperature value of the heater back thermistor 19 can be stably maintained at a desired temperature.

A storage unit 29 stores individual information regarding heat responsiveness that is provided in the fixing device 100. This apparatus employs a non-volatile memory, such as an NVRAM, but may employ the format of an IC tag such as RFID or a QR code (registered trademark). When the fixing device 100 is attached to the image forming apparatus, the storage unit 29 in this example reads the stored information using a reading unit 50 in the image forming apparatus. The information read by the reading unit 50 is sent to the control unit 21 and utilized to determine the adjusted temperature of the fixing belt 20 by the storage unit 29 and the control unit (CPU) 21 of the image forming apparatus communicating with each other.

The information stored in the storage unit 29 will be described below.

### <Storage of Information in Memory>

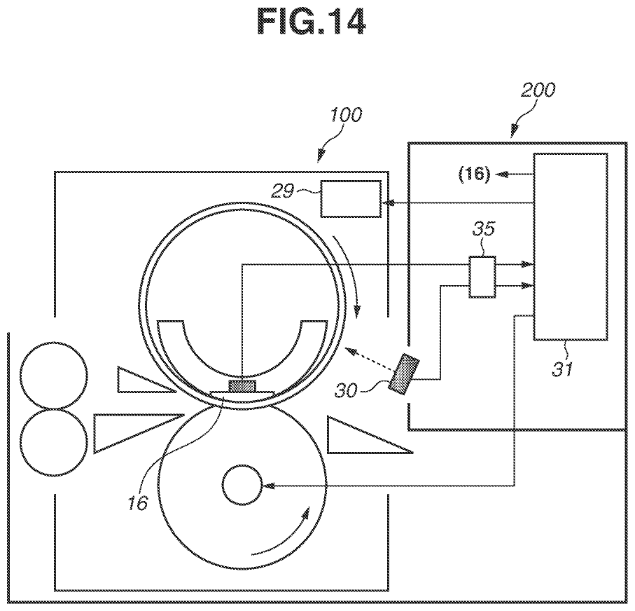

FIG. 14 is a diagram illustrating the configuration of a fixing device heat characteristic measurement jig 200 installed in the final process after the completion of the fixing device 100 in the process of manufacturing the fixing device 100. The measurement jig 200 measures temperature rise characteristic information regarding the heater 16 or the fixing belt 20 as the heat response characteristic of the fixing device 100 and stores the temperature rise characteristic information as information in the storage unit 29 of the fixing device 100.

The measurement jig 200 can perform drive and belt inner surface temperature adjustment control in the state where the fixing device 100 is alone. The measurement jig 200 can output the detection value of the heater back thermistor 19 via an A/D converter 35 within the jig 200, and at the same time, synchronously measure the temperature of the surface of the fixing belt 20 using a non-contact temperature detection unit 30 installed in the jig 200.

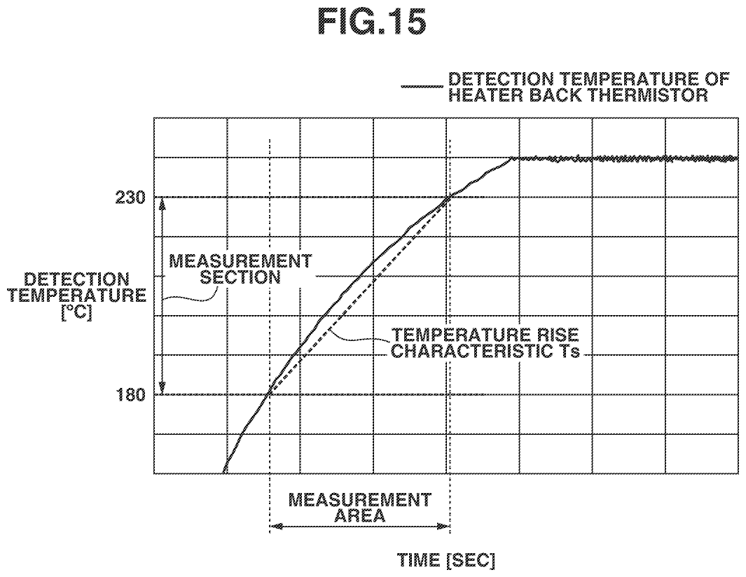

FIG. 15 illustrates start-up temperature transition acquired by the measurement jig 200 measuring a certain specific fixing device 100. Measurement conditions in this example were as follows.

After the completion of the fixing device 100, the measurement was started from a normal temperature stable state (25±4° C.). The start-up power of the heater 16 was 500 W±3%. The adjusted temperature of the heater back thermistor 19 was 240° C. The driving time was 60 seconds from when the fixing belt 20 reached the adjusted temperature. Regarding temperature rise characteristics information Ts to be written to the storage unit 29 in the present exemplary embodiment, the rising temperature per unit time of the fixing device 100 measured under the above measurement conditions during start-up temperature transition from 180° C. to 230° C. is the temperature rise characteristic.

The above measurement conditions are conditions for detecting the difference between each individual with high accuracy, and are not limited to the above values.

A calculation processing unit 31 within the measurement jig 200 stores either one or both of the detection temperature of the heater back thermistor 19 and the detection temperature of the non-contact temperature detection unit 30 during the above start-up period in a sampling period of 100 ms. After the completion of the measurement, the calculation processing unit 31 calculates the temperature rise characteristic information Ts and executes an operation of writing the temperature rise characteristic information Ts to the storage unit 29 in the fixing device 100.

In the measurement jig 200 for the fixing device 100 described here, the surface temperature measurement point of the fixing belt 20 is an area immediately before the nip in the rotational direction in this example, but may be any peripheral position. Alternatively, the temperature of the surface of the fixing belt 20 may be measured at a plurality of points or by performing continuous scanning in the longitudinal direction of the fixing device 100.

The specific temperature rise characteristic information Ts stored in the storage unit 29 is utilized to correct a permission temperature when the fixing device 100 is attached to the image forming apparatus and caused to operate. The method will be described in detail in the following paragraphs.

### <Image Forming Processing 1>

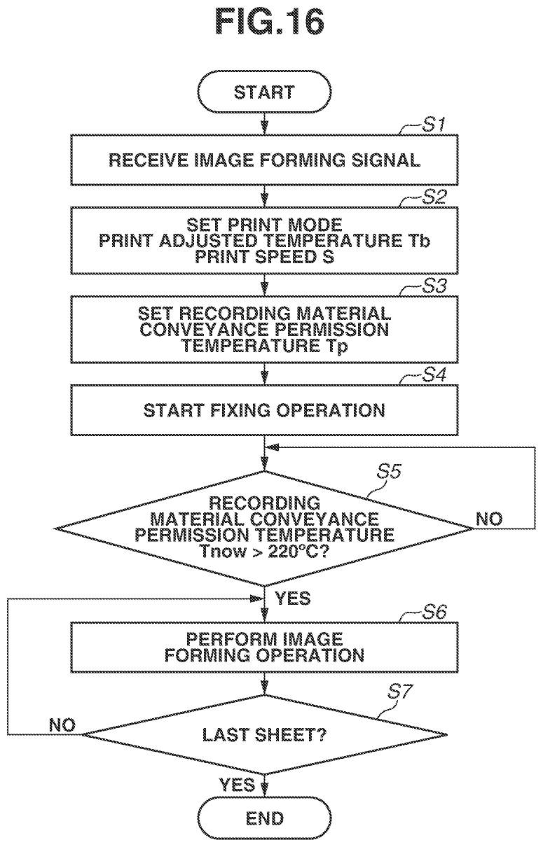

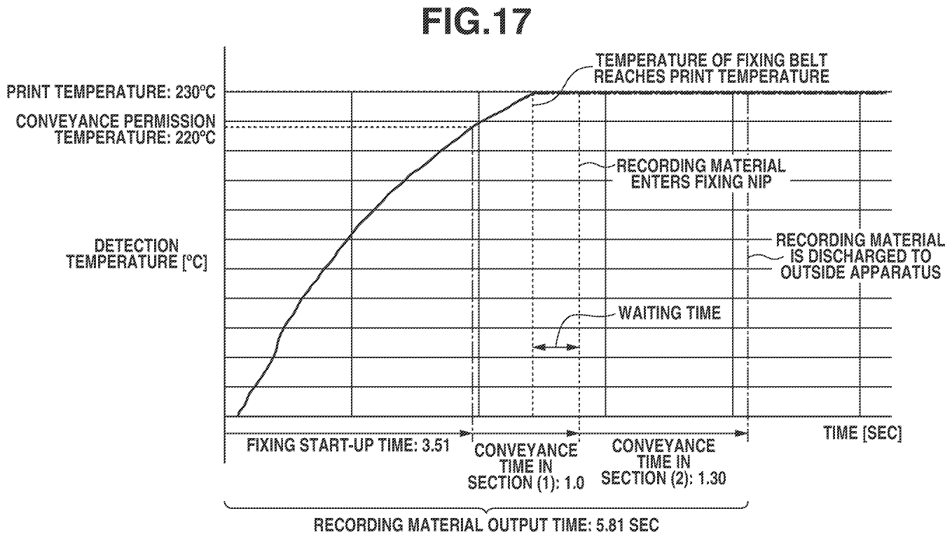

With reference to a flowchart in FIG. 16, a diagram illustrating temperature transition in FIG. 17, and a diagram illustrating the conveyance path of a recording material before and after the fixing device in FIG. 8, image forming processing in a comparative example is described.

In step S1, if the control unit 21 receives an image forming signal, then in step S2, the control unit 21 sets a print mode.

At this time, the control unit 21 performs temperature adjustment control of the fixing belt 20 based on the detection temperature of the heater back thermistor 19. In the temperature adjustment control, recording material information (the type, the grammage, and the size) regarding a recording material used in the image formation, image information (a monochrome mode or a color mode), and outside air temperature information are used. In the present exemplary embodiment, the control unit 21 determines a target temperature Tb and a print speed S based on an internal table. For example, the control unit 21 sets plain paper of 64 gsm (the recording material information), the color mode (the image information), and Tb=200° C. and S=100% in a 25° C. environment (the outside air temperature information).

Next, in step S3, the control unit 21 sets a permission temperature Tp that is a predetermined temperature for permitting the conveyance of the recording material.

The permission temperature Tp is determined based on the conveyance path length (a conveyance section (1) illustrated in FIG. 8) of the image forming apparatus. When the heater 16 is started up with the maximum setting power, the control unit 21 starts an image forming operation on the photosensitive drums 101 at a timing when the detection temperature is lower by ΔT° C. than when the fixing belt 20 reaches the print adjusted temperature Tb. As a result, the recording material bearing a toner image is conveyed to the nip portion 27 just at the timing when the fixing belt 20 reaches the temperature Tb.

After a print instruction is received, the fixing device 100 according to the present exemplary embodiment starts heating the fixing heater 16 so that the fixing heater 16 reaches the target temperature Tb. At this time, if the conveyance unit 140 starts feeding the sheet from the sheet feeding cassette 130 after the fixing heater 16 reaches the target temperature Tb, FCOT becomes late. Accordingly, the FCOT is hastened by setting the permission temperature Tp to a temperature lower than the target temperature Tb.

In the comparative example, using a fixing device 100 having the lowest temperature rise characteristic information Ts among variations in the fixing device 100 as a reference, the permission temperature Tp=220° C. is set to a reference.

The individual fixing device 100 having the lowest temperature rise characteristic is used as a reference, so that it is possible to avoid the occurrence of defective fixing occurs caused by the fixing heater 16 to reach the print adjusted temperature Tb at the time when the recording material reaches the nip portion 27.

In step S4, the control unit 21 starts driving the pressure rotating member 22 and also starts applying a current to the heater 16 via the heater driving control unit 28.

In step S5, if a detection temperature Tnow of the heater back thermistor 19 satisfies a conditional expression (Tnow>220° C.) (YES in step S5), then in step S6, the control unit 21 permits the feeding of the recording material and transmits a command to form images on the photosensitive drums 101.

In this manner, in step S6, the control unit 21 repeats an image forming operation while controlling the temperature of the fixing heater 16. In step S7, if the control unit 21 detects the last sheet (YES in step S7), an image forming operation end process (the stop of the temperature adjustment, the turning off of high-voltage components, and the stop of the driving mechanism) is completed, and the series of processes of the flowchart is ended.

FIG. 17 illustrates the transition of the output of the heater back thermistor 19 when a fixing device 100 having a high temperature rise characteristic prints plain paper in the comparative example.

In FIG. 17, the time until the recording material is output is 5.81 seconds. A breakdown of the time is as follows. It takes 3.51 seconds from when the application of a current to the heater 16 is started to when the detection temperature reaches a conveyance permission temperature Tp of 220° C. It takes 1.0 second for the recording material to be conveyed through the section (1) after that. It takes 1.3 seconds for the recording material to pass through the nip portion 27 and the rear end of the recording material to be discharged to outside the apparatus in the section (2). The conveyance times in the sections (1) and (2) are determined based on the conveyance path length and the conveyance speed and therefore are constant regardless of the individuality of the fixing device 100.

However, during the conveyance time in the section (1) from when the detection temperature reaches the conveyance permission temperature Tp to when the recording material enters the nip portion 27, the temperature of the heater 16 quickly reaches the print adjusted temperature Tb, and the fixing device 100 is in the state where the fixing device 100 waits for the recording material to enter the nip portion 27. This is because, as described above, the permission temperature Tp is set using the individual fixing device 100 having the lowest temperature rise characteristic as a reference, and therefore does not match the temperature rise speed of the fixing device 100 having a high temperature rise characteristic.

### <Image Forming Processing 2>

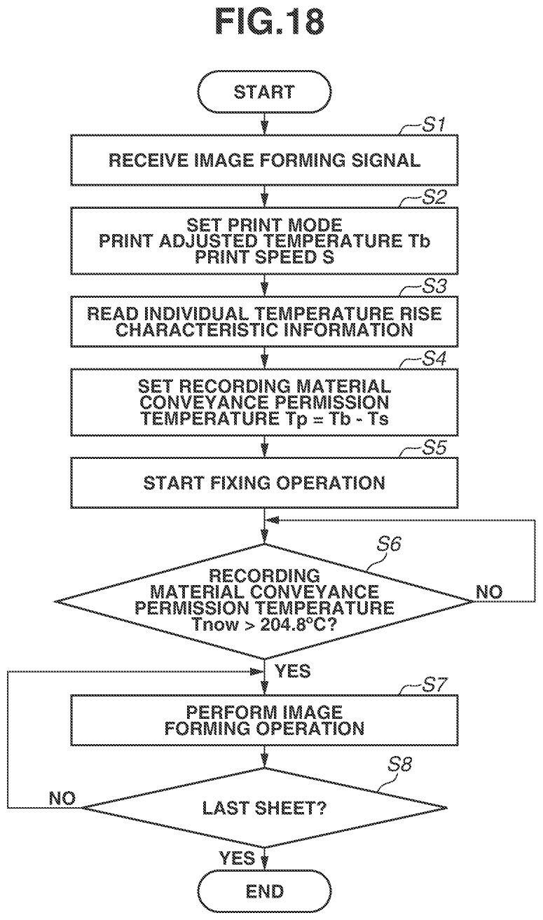

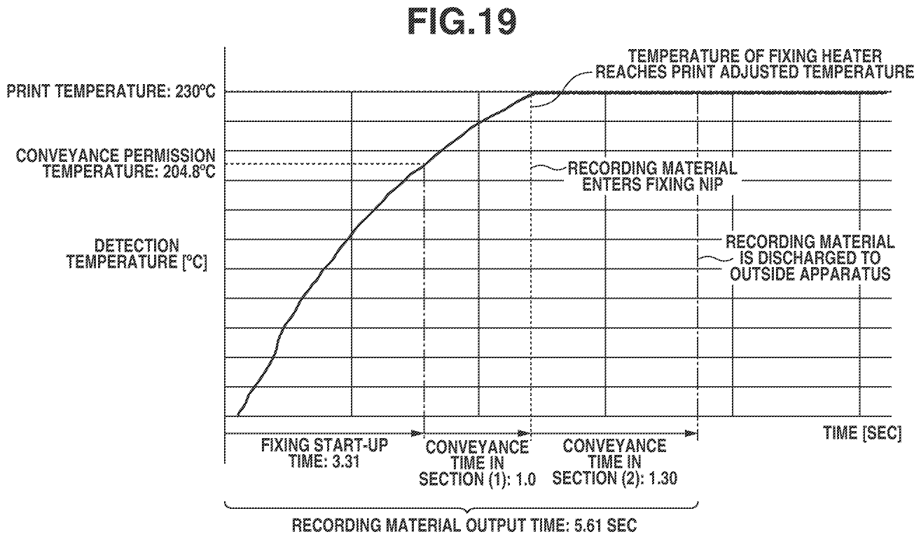

Next, with reference to a flowchart in FIG. 18 and a diagram illustrating temperature transition in FIG. 19, image forming processing according to the present exemplary embodiment is described.

The operations in steps S1 and S2 are similar to those in the comparative example, and therefore are not described. In step S3, the control unit 21 calculates a permission temperature Tp based on the information Ts regarding the temperature rise characteristic in the storage unit 29 of the fixing device 100 read by the reading unit 50. The information regarding the temperature rise characteristic described here is the rising temperature per unit time measured in the above assembling process.

Next, in step S4, the control unit 21 determines the permission temperature Tp according to the following equation using the temperature rise characteristic information

$$Ts = 15.2 ( ° C . / sec ) and the print adjusted temperature Tb . \\ Tp = Tb - \{ Ts \times the time required to pass through the conveyance section ( 1 ) \}$$

Since the time required to pass through the conveyance section (1) is 1 second, Tp=220−15.2=204.8° C. in this example.

In this example, the sheet is passed in the plain paper mode from the state where the fixing device 100 is cold in a normal environment. Alternatively, as in an ambient temperature, a print speed, and a heat accumulation state, correction coefficients for the respective items may be applied based on information regarding a high-temperature environment, low-speed sheet passage, and the elapsed time from a previous job, thereby calculating an optimal temperature correction value Tp′.

If a detection temperature Tnow of the heater back thermistor 19 satisfies a conditional expression (Tnow>204.8° C.) (YES in step S6), then in step S7, the control unit 21 permits the feeding of the recording material. The conveyance unit 140 conveys the recording material from the sheet feeding cassette 130. Further, the control unit 21 transmits a command to form images on the photosensitive drums 101.

In this manner, in step S7, the control unit 21 repeats an image forming operation while controlling the temperature of the fixing heater 16. In step S8, if the control unit 21 detects the last sheet (YES in step S8), an image forming operation end process (the stop of the temperature adjustment, the turning off of high-voltage components, and the stop of the driving mechanism) is completed, and the series of processes of the flowchart is ended.

FIG. 19 illustrates the transition of the output of the heater back thermistor 19 when a fixing device 100 having a high temperature rise characteristic prints plain paper using the control in this example.

In FIG. 19, the time until the recording material is output is 5.61 seconds, which is 0.2 seconds faster than in the comparative example.

A breakdown of the time is as follows. It takes 3.31 seconds from when the application of a current to the heater 16 is started to when the detection temperature reaches a conveyance permission temperature Tp of 204.8° C. It takes 1.0 second for the recording material to be conveyed through the section (1) after that. It takes 1.3 seconds for the recording material to pass through the nip portion 27 and the rear end of the recording material to be discharged to outside the apparatus in the section (2).

In this example, the conveyance permission temperature Tp is corrected using the temperature rise characteristic of each individual fixing device 100, so that the fixing belt 20 reaches the print adjusted temperature Tb at the timing when the recording material is conveyed and enters the nip portion 27. Thus, a waiting time does not occur.

As described above, as a result of actually evaluating sheet passage in the fixing device 100 for which the print adjusted temperature Tb of the temperature of the heater 16 is determined to be 230° C. according to the image forming process in FIG. 18, it has been demonstrated that as illustrated in FIG. 19, the time from when the application of a current to the heater 16 is started to when the first recording material is output can be shortened as follows: 5.61 seconds in the control according to the present disclosure whereas 5.81 seconds in the comparative control.

In the present exemplary embodiment, the temperature rise per unit time of the fixing heater 16 measured in the assembling process is stored as the temperature rise characteristic in a memory and used as a conveyance permission temperature correction value in a printing operation. Similarly, the time required to rise to a predetermined temperature when certain power is input to a heat source may be stored as the temperature rise characteristic in a memory and used as a conveyance permission temperature correction value in a printing operation.

A third exemplary embodiment of the present disclosure will be described below. In the third exemplary embodiment, the conveyance permission temperature is controlled based on a belt surface temperature detection unit 32. Portions similar to those of the first and second exemplary embodiments are not described below, and only different portions are described below.

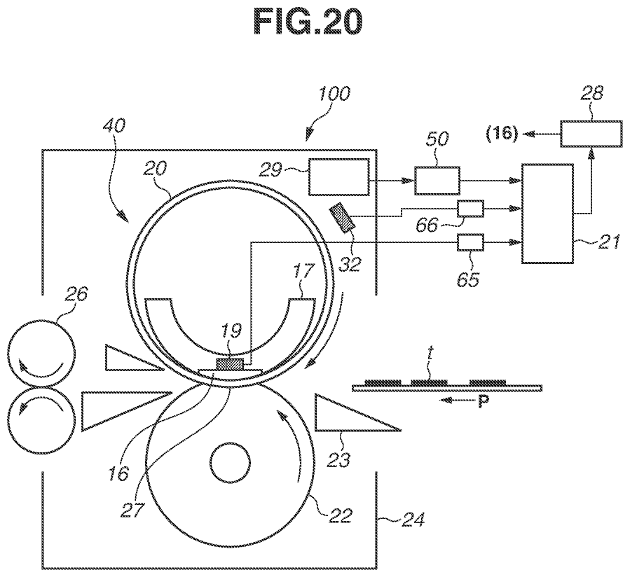

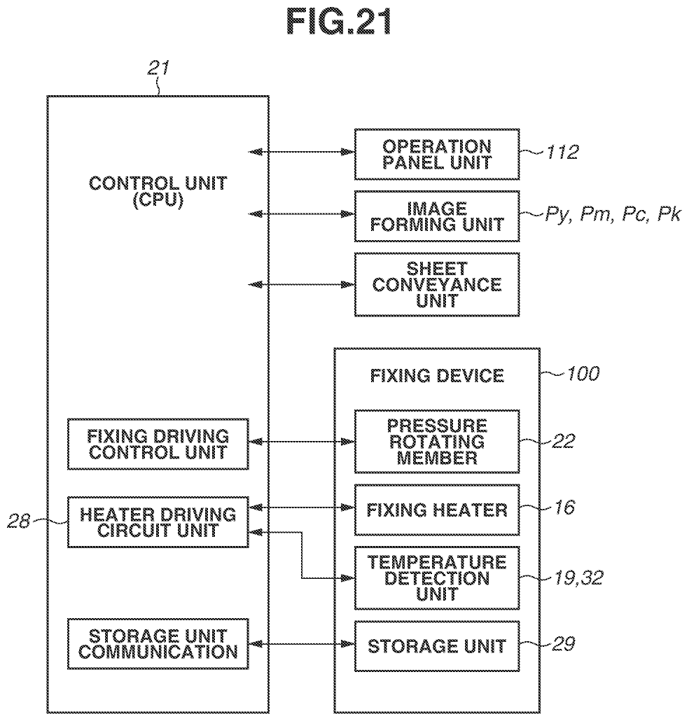

FIG. 20 is a diagram illustrating a sectional configuration of the fixing device 100 according to the present exemplary embodiment. The present exemplary embodiment is different from the first exemplary embodiment in that the fixing device 100 does not have a belt back thermistor, and has a belt surface temperature detection unit 32. FIG. 21 is a control block diagram according to the present exemplary embodiment.

### <Fixing Device>

The fixing device 100 includes temperature detection units. In the width direction of the recording material orthogonal to the conveyance direction of the recording material, the temperature detection units detect the temperatures of a sheet passage area through which the recording material passes. Temperature detection units 19 and 32 detect the temperatures of the heating unit 40. The detection temperatures detected by the temperature detection units 19 and 32 are used to control the fixing belt 20 at a target temperature. If the temperature detection unit 19 or 32 detects an excessive temperature rise, the temperature detection unit 19 or 32 determines that an error occurs. Then, control to suspend a print job is performed. The temperature detection unit 19 according to the present exemplary embodiment is a thermistor, and the temperature detection unit 32 is a non-contact temperature detection unit. More specifically, the temperature detection unit 19 is a thermistor (a heater back thermistor) that detects the temperature of the back surface of the heater 16 (a surface opposite to the surface that slides in contact with the fixing belt 20). The temperature detection unit 32 is a non-contact temperature detection unit that detects the temperature of the surface of the belt 20. The heater back thermistor 19 and the non-contact temperature detection unit 32 are connected to the control unit (CPU) 21 serving as a control unit via A/D converters 65 and 66, respectively. The control unit 21 samples the output from the non-contact temperature detection unit 32 in a predetermined period and is configured to reflect the thus obtained temperature information on temperature control. That is, based on the output of the non-contact temperature detection unit 32, the control unit 21 determines the details of temperature adjustment control of the heater 16 and controls the application of a current to the heater 16 using a heater driving control unit 28 that is a power supply unit. The temperature adjustment control method of the fixing device 100 determines the value of power supplied to the heater 16 mainly so that the detection temperature value of the non-contact temperature detection unit 32 that detects the temperature of the surface of the belt 20 can be stably maintained at a desired temperature.

A storage unit 29 stores individual information regarding heat responsiveness that is provided in the fixing device 100. This apparatus employs a non-volatile memory such as an NVRAM, but may employ the format of an IC tag such as RFID or a QR code (registered trademark). When the fixing device 100 is attached to the image forming apparatus, the storage unit 29 in this example reads the stored information using a reading unit 50 in the image forming apparatus. The information read by the reading unit 50 is sent to the control unit 21 and utilized to determine the adjusted temperature of the fixing belt 20 by the storage unit 29 and the control unit (CPU) 21 of the image forming apparatus communicating with each other.

The information stored in the storage unit 29 will be described below. In the present exemplary embodiment, the fixing device 100 has the temperature detection unit 32. The present disclosure, however, is not limited to this form, and may employ a form in which a main body outside the fixing device 100 may have the temperature detection unit 32.

### <Storage of Information in Memory>

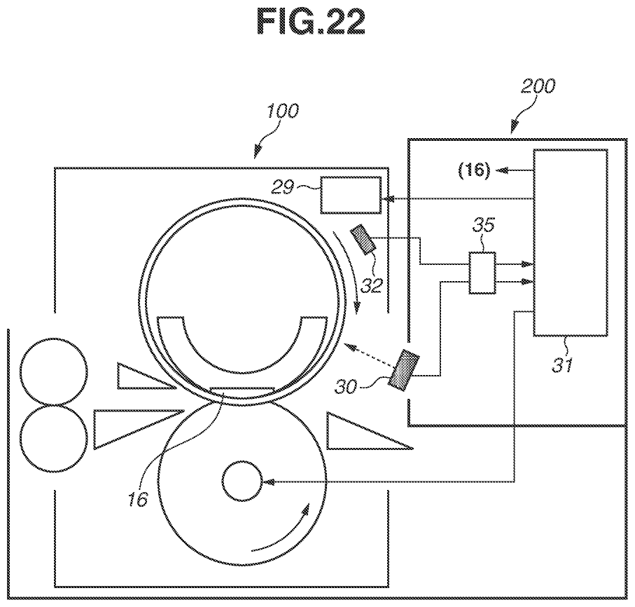

FIG. 22 is a diagram illustrating the configuration of a fixing device heat characteristic measurement jig 200 that is installed in the final process after the completion of the fixing device 100 in the process of manufacturing the fixing device 100. The measurement jig 200 measures temperature rise characteristic information regarding the heater 16 or the fixing belt 20 as the heat response characteristic of the fixing device 100 and stores the temperature rise characteristic information as information in the storage unit 29 of the fixing device 100.

The measurement jig 200 can drive and belt inner surface temperature adjustment control in the state where the fixing device 100 is alone. The measurement jig 200 can output the detection value of the non-contact temperature detection unit 32 on the surface of the belt 20 via an A/D converter 35 within the jig 200, and at the same time, synchronously measure the temperature of the surface of the fixing belt 20 using a non-contact temperature detection unit 30 installed in the jig 200.

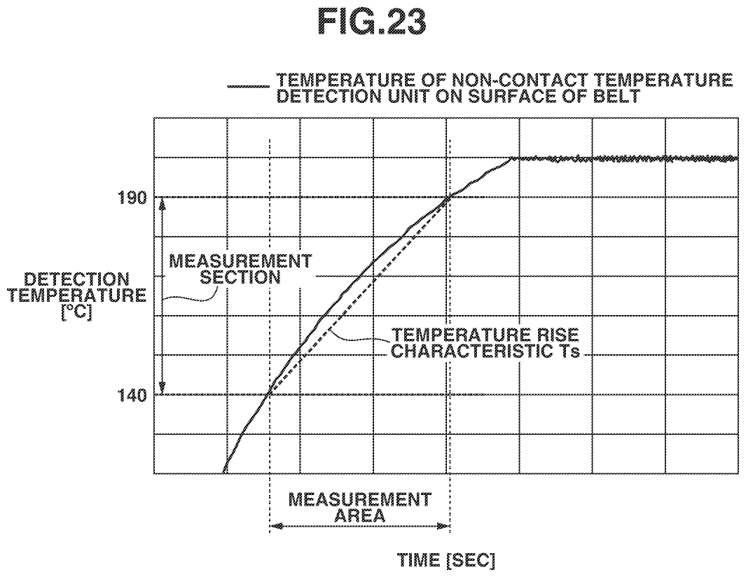

FIG. 23 illustrates start-up temperature transition acquired by the measurement jig 200 measuring a certain specific fixing device 100. Measurement conditions in this example were as follows.

After the completion of the fixing device 100, the measurement was started from a normal temperature stable state (25±4° C.). The start-up power of the heater 16 was 500 W±3%. The adjusted temperature of the non-contact temperature detection unit 32 on the surface of the belt 20 was 200° C. The driving time was 60 seconds from when the fixing belt 20 reached the adjusted temperature. Regarding temperature rise characteristics information Ts to be written to the storage unit 29 in the present exemplary embodiment, the rising temperature per unit time of the fixing device 100 measured under the above measurement conditions during start-up temperature transition from 140° C. to 190° C. is the temperature rise characteristic.

The above measurement conditions are conditions for detecting the difference between each individual with high accuracy, and are not limited to the above values.

A calculation processing unit 31 within the measurement jig 200 stores either one or both of the detection temperature of the non-contact temperature detection unit 32 on the surface of the belt 20 and the detection temperature of the non-contact temperature detection unit 30 during the above start-up period in a sampling period of 100 ms. After the completion of the measurement, the calculation processing unit 31 calculates the temperature rise characteristic information Ts and executes an operation of writing the temperature rise characteristic information Ts to the storage unit 29 in the fixing device 100.

In the measurement jig 200 of the fixing device 100 described here, the surface temperature measurement point of the fixing belt 20 is an area immediately before the nip in the rotational direction in this example, but may be any peripheral position. Alternatively, the temperature of the surface of the fixing belt 20 may be measured at a plurality of points or by performing continuous scanning in the longitudinal direction of the fixing device 100.

The specific temperature rise characteristic information Ts stored in the storage unit 29 is utilized to correct a permission temperature when the fixing device 100 is attached to the image forming apparatus and caused to operate. The method will be described in detail in the following paragraphs.

### <Image Forming Processing 1>

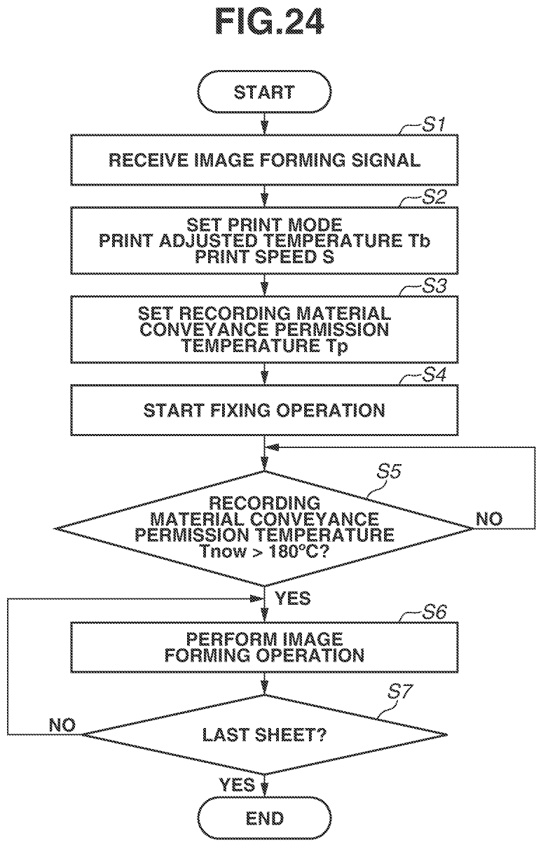

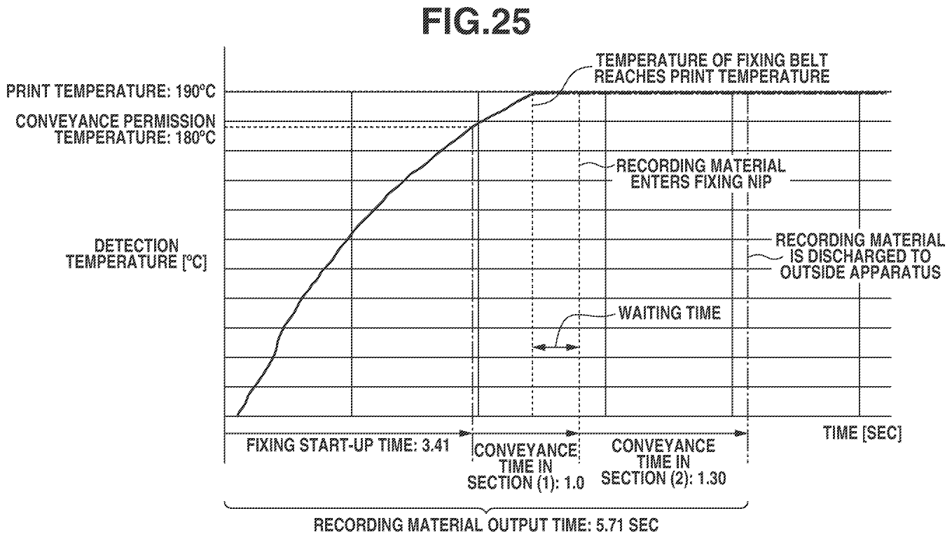

With reference to a flowchart in FIG. 24, a diagram illustrating temperature transition in FIG. 25, and a diagram illustrating the conveyance path of a recording material before and after the fixing device in FIG. 8, an image forming process in a comparative example is described.

In step S1, if the control unit 21 receives an image forming signal, then in step S2, the control unit 21 sets a print mode.

At this time, the control unit 21 performs temperature adjustment control of the fixing belt 20 based on the detection temperature of the non-contact temperature detection unit 32 on the surface of the belt 20. In the temperature adjustment control, recording material information (the type, the grammage, and the size) regarding a recording material used in the image formation, image information (a monochrome mode or a color mode), and outside air temperature information are used. In the present exemplary embodiment, the control unit 21 determines a target temperature Tb and a print speed S based on an internal table. For example, the control unit 21 sets plain paper of 64 gsm (the recording material information), the color mode (the image information), and Tb=200° C. and S=100% in a 25° C. environment (the outside air temperature information).

Next, in step S3, the control unit 21 sets a permission temperature Tp that is a predetermined temperature for permitting the conveyance of the recording material.

The permission temperature Tp is determined based on the conveyance path length (a conveyance section (1) illustrated in FIG. 8) of the image forming apparatus. When the heater 16 is started up with the maximum setting power, the control unit 21 starts an image forming operation on the photosensitive drums 101 at a timing when the detection temperature is lower by ΔT° C. than when the fixing belt 20 reaches the print adjusted temperature Tb. As a result, the recording material bearing a toner image is conveyed to the nip portion 27 just at the timing when the fixing belt 20 reaches the temperature Tb.

After a print instruction is received, the fixing device 100 according to the present exemplary embodiment starts heating the fixing heater 16 so that the fixing heater 16 reaches the target temperature Tb. At this time, if the conveyance unit 140 starts feeding the sheet from the sheet feeding cassette 130 after the fixing heater 16 reaches the target temperature Tb, FCOT becomes late. Accordingly, the FCOT is hastened by setting the permission temperature Tp to a temperature lower than the target temperature Tb.

In the comparative example, using a fixing device 100 having the lowest temperature rise characteristic information Ts among variations in the fixing device 100 as a reference, the permission temperature Tp=180° C. is set to a reference.

The individual fixing device 100 having the lowest temperature rise characteristic is used as a reference, so that it is possible to avoid the occurrence of defective fixing caused by the fixing heater 16 failing to reach the print adjusted temperature Tb at the time when the recording material reaches the nip portion 27.

In step S4, the control unit 21 starts driving the pressure rotating member 22 and also starts applying a current to the heater 16 via the heater driving control unit 28.

In step S5, if a detection temperature Tnow of the non-contact temperature detection unit 32 on the surface of the belt 20 satisfies a conditional expression (Tnow>180° C.) (YES in step S5), then in step S6, the control unit 21 permits the feeding of the recording material and transmits a command to form images on the photosensitive drums 101.

In this manner, in step S6, the control unit 21 repeats an image forming operation while controlling the temperature of the fixing heater 16. In step S7, if the control unit 21 detects the last sheet (YES in step S7), an image forming operation end process (the stop of the temperature adjustment, the turning off of high-voltage components, and the stop of the driving mechanism) is completed, and the series of processes of the flowchart is ended.

FIG. 25 illustrates the transition of the output of the non-contact temperature detection unit 32 on the surface of the belt 20 when a fixing device 100 having a high temperature rise characteristic prints plain paper in the comparative example.

In FIG. 25, the time until the recording material is output is 5.71 seconds. A breakdown of the time is as follows. It takes 3.41 seconds from when the application of a current to the heater 16 is started to when the detection temperature reaches a conveyance permission temperature Tp of 180° C. It takes 1.0 second for the recording material to be conveyed through the section (1) after that. It takes 1.3 seconds for the recording material to pass through the nip portion 27 and the rear end of the recording material to be discharged to outside the apparatus in the section (2). The conveyance times in the sections (1) and (2) are determined based on the conveyance path length and the conveyance speed and therefore are constant regardless of the individuality of the fixing device 100.

However, during the conveyance time in the section (1) from when the detection temperature reaches the conveyance permission temperature Tp to when the recording material enters the nip portion 27, the temperature of the surface of the belt 20 quickly reaches the print adjusted temperature Tb, and the fixing device 100 is in the state where the fixing device 100 waits for the recording material to enter the nip portion 27. This is because, as described above, the permission temperature Tp is set using the individual fixing device 100 having the lowest temperature rise characteristic as a reference, and therefore does not match the temperature rise speed of the fixing device 100 having a high temperature rise characteristic.

### <Image Forming Processing 2>

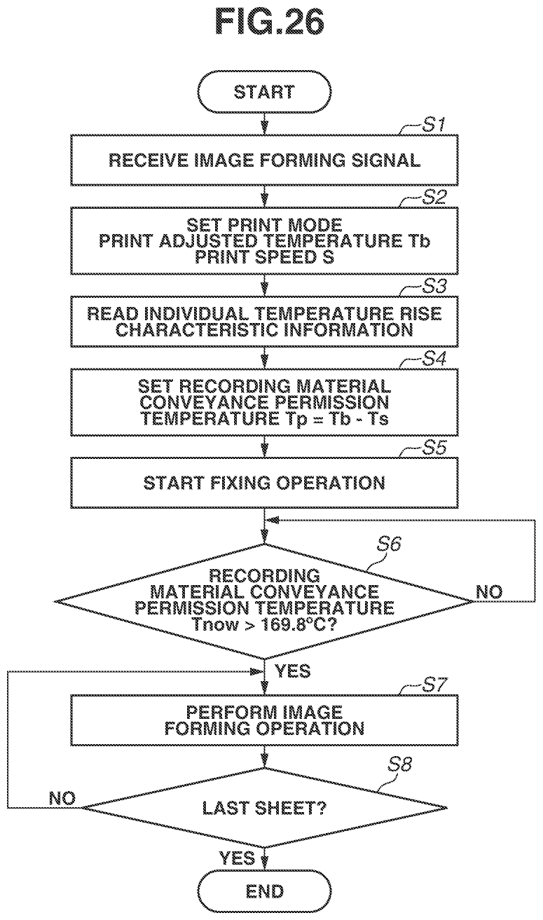

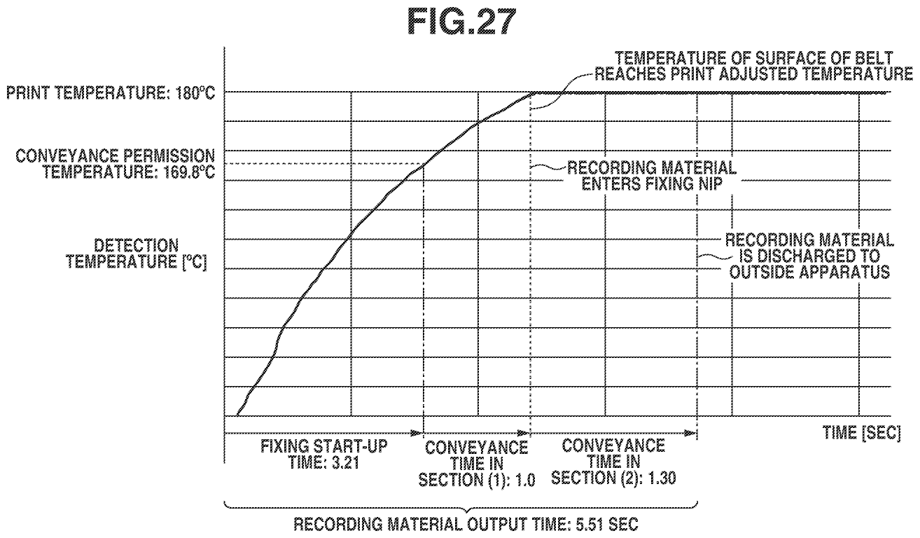

Next, with reference to a flowchart in FIG. 26 and a diagram illustrating temperature transition in FIG. 27, an image forming process according to the present exemplary embodiment is described.

The operations in steps S1 and S2 are similar to those in the comparative example, and therefore are not described. In step S3, the control unit 21 calculates a permission temperature Tp based on the information Ts regarding the temperature rise characteristic in the storage unit 29 of the fixing device 100 read by the reading unit 50. The information regarding the temperature rise characteristic described here is the rising temperature per unit time measured in the above assembling process.

Next, in step S4, the control unit 21 determines the permission temperature Tp according to the following formula using the temperature rise characteristic information Ts=15.2 (° C./sec) and the print adjusted temperature Tb.

Tp=Tb−{Ts×the time required to pass through the conveyance section (1)} Since the time required to pass through the conveyance section (1) is 1 second, Tp=180−10.2=169.8° C. in this example.

In this example, the sheet is passed in the plain paper mode in the state where the fixing device 100 is cold in a normal environment. Alternatively, as in an ambient temperature, a print speed, and a heat accumulation state, correction coefficients for the respective items may be applied based on information regarding a high-temperature environment, low-speed sheet passage, and the elapsed time from a previous job, thus calculating an optimal temperature correction value Tp′.

If a detection temperature Tnow of the non-contact temperature detection unit 32 on the surface of the belt 20 satisfies a conditional expression (Tnow>169.8° C.) (YES in step S6), then in step S7, the control unit 21 permits the feeding of the recording material. The conveyance unit 140 conveys the recording material from the sheet feeding cassette 130. Further, the control unit 21 transmits a command to form images on the photosensitive drums 101.

In this manner, in step S7, the control unit 21 repeats an image forming operation while controlling the temperature of the fixing heater 16. In step S8, if the control unit 21 detects the last sheet (YES in step S8), an image forming operation end process (the stop of the temperature adjustment, the turning off of high-voltage components, and the stop of the driving mechanism) is completed, and the series of processes of the flowchart is ended.

FIG. 27 illustrates the transition of the output of the temperature of the surface of the belt 20 when a fixing device 100 having a high temperature rise characteristic prints plain paper using the control in this example.

In FIG. 27, the time until the recording material is output is 5.51 seconds, which is 0.2 seconds faster than in the comparative example.

A breakdown of the time is as follows. It takes 3.21 seconds from when the application of a current to the heater 16 is started to when the detection temperature reaches a conveyance permission temperature Tp of 169.8° C. It takes 1.0 second for the recording material to be conveyed through the section (1) after that. It takes 1.3 seconds for the recording material to pass through the nip portion 27 and the rear end of the recording material to be discharged to outside the apparatus in the section (2).

In this example, the conveyance permission temperature Tp is corrected using the temperature rise characteristic of each individual fixing device 100, so that the fixing belt 20 reaches the print adjusted temperature Tb at the timing when the recording material is conveyed and enters the nip portion 27. Thus, a waiting time does not occur.

As described above, as a result of actually evaluating sheet passage in the fixing device 100 in which the print adjusted temperature Tb of the temperature of the surface of the belt 20 is determined as 180° C. according to the image forming processing in FIG. 26, it has been demonstrated that as illustrated in FIG. 27, the time from when the application of a current to the heater 16 is started to when the first recording material is output can be shortened from 5.71 seconds in the comparative control to 5.51 seconds in the control according to the present disclosure.

In the present exemplary embodiment, the temperature rise per unit time of the fixing heater 16 measured in the assembling process is stored as the temperature rise characteristic in a memory and used as a conveyance permission temperature correction value in a printing operation. Similarly, the time required to rise to a predetermined temperature when certain power is input to a heat source may be stored as the temperature rise characteristic in a memory and used as a conveyance permission temperature correction value in a printing operation.

In the first, second, and third exemplary embodiments, control is executed based on the results of measuring the temperature of the fixing belt and the temperature of the fixing heater. The present disclosure, however, is not limited to the above. Based on the result of measuring the pressure rotating member, the conveyance permission temperature may be determined.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described Embodiments and/or that includes one or more circuits (e.g., application specific integrated circuit (ASIC)) for performing the functions of one or more of the above-described Embodiments, and by a method performed by the computer of the system or apparatus by, for example, reading out and executing the computer executable instructions from the storage medium to perform the functions of one or more of the above-described Embodiments and/or controlling the one or more circuits to perform the functions of one or more of the above-described Embodiments. The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read-only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Applications No. 2023-065266, filed Apr. 12, 2023, and No. 2023-117863, filed Jul. 19, 2023, which are hereby incorporated by reference herein in their entirety.

What is claimed is:

1. An image forming apparatus comprising:
a fixing device configured to fix a toner image onto a recording material,
wherein the fixing device includes:
a heating unit configured to apply heat to the recording material,
a pressure rotating member configured to abut the heating unit to form a nip portion,
a temperature detection unit configured to detect a temperature of the heating unit, and
a storage unit configured to store information regarding a temperature rise rate of the fixing device,
a reading unit configured to read the information stored in the storage unit,
a sheet feeding unit configured to feed the recording material,
a conveyance unit configured to convey the recording material from the sheet feeding unit to the nip portion, and
a control unit configured to control, when the recording material is conveyed to the nip portion, the heating unit at a target temperature,
wherein, in a case where a predetermined temperature lower than the target temperature is reached, the control unit controls the conveyance unit to start conveying the recording material from the sheet feeding unit to the nip portion, and
wherein, in determining the predetermined temperature, the control unit further determines the predetermined temperature based on the information read by the reading unit.

2. The image forming apparatus according to claim 1, wherein, in a width direction of the recording material orthogonal to a conveyance direction of the recording material, the temperature detection unit detects a temperature of a sheet passage area through which the recording material passes.

3. The image forming apparatus according to claim 1, wherein the fixing device includes a cover covering the heating unit and the pressure rotating member, and the storage unit is placed on an inner peripheral surface of the cover.

4. The image forming apparatus according to claim 1, wherein the temperature rise rate is a temperature rise rate per unit time of the heating unit.

5. The image forming apparatus according to claim 1, wherein the heating unit includes a fixing belt that is endless and rotatable, and a heater configured to heat the fixing belt.

6. The image forming apparatus according to claim 5, wherein, in heating the fixing belt, the heater heats the fixing belt in contact with an inner peripheral surface of the fixing belt.

7. The image forming apparatus according to claim 6, wherein the heater is configured to nip the fixing belt with the pressure rotating member.

8. The image forming apparatus according to claim 5, wherein the information regarding a temperature rise rate of the fixing device further includes information regarding the fixing belt.

9. A fixing device comprising:
a heating unit configured to apply heat to a recording material;
a pressure rotating member configured to abut the heating unit to form a nip portion; and
a storage unit configured to store information regarding a temperature rise rate of the fixing device,
wherein the pressure rotating member and the heating unit are configured to apply heat and pressure to the recording material to fix a toner image to the recording material.
